(19) United States
(12) Patent Application Publication
(10) Pub. No.: US 2014/0291459 A1
(43) Pub. Date: Oct. 2, 2014

(54) DETACHABLE HOOK AND CLIP WITH A VIEW ANGLE ADJUSTER FOR HANGING AN ELECTRONIC DEVICE

(71) Applicant: Eddie Somuah, Milford, CT (US)

(72) Inventor: Eddie Somuah, Milford, CT (US)

(21) Appl. No.: 13/851,068

(22) Filed: Mar. 26, 2013

(51) Int. Cl. F16M 13/02

(52) U.S. Cl. CPC F16M 13/022
USPC 248/201

(57) ABSTRACT

A detachable hook or clip with view angle adjuster can be used for hanging an electronic device in various settings. The device includes a flexible hook or clip and a view angle adjuster that may be made of, for example, plastic or metal. The flexible hook or clip may be attached to the back of an electronic device using, for example, a magnetic bar, hook and loop fasteners, suction cup or the like. The hook or clip may be used to suspend the electronic device from any appropriate fixture, such as a seat back in an automobile, train, aircraft, or the like. The view angle adjuster may be attached to the lower portion of the electronic device and may be used to tilt the viewing angle of the hanging electronic device. The device be stowed when not in use.

### BACKGROUND OF THE INVENTION

The present invention relates to hanging devices and, more particularly, to a detachable hook and clip with a view angle adjuster for hanging an electronic device.

The growing number of electronic devices, such as Ipad®, Kindle® and Nook®, in the fast pace economy has become synonymous with reading, playing or watching movies on the bus, train, aircraft and other modes of transportation. Since these devices are new technologies, vehicles and aircraft are not equipped with convenient accessories to allow passengers to uses these products without having to balance them on their lap, on the floor, on a tray table or the like.

Current electronic devices do not provide support for hanging them in various settings. The current use of electronic devices, with inadequate or incorrect support, may cause back strain, neck strain or accidental damage to the electronic device if it gets dropped, kicked or if something is dropped on it.

As can be seen, there is a need for a detachable hook and clip with an adjustable view angle for hanging an electronic device.

### SUMMARY OF THE INVENTION

In one aspect of the present invention, a device for supporting an electronic device comprises at least one of a hook or a clip removably attached to an upper portion of a back housing of the electronic device, the hook and clip adapted to suspend the electronic device from a desired object; and a view angle adjuster having a base removably attached to a lower portion of the back housing of the electronic device, the view angle adjuster having a tilt arm adapted to set an angle of the electronic device relative to the desired object.

In another aspect of the present invention, a device for supporting an electronic device comprises at least one of a U-shaped hook or a clip removably attached to an upper portion of a back housing of the electronic device, the hook and clip adapted to suspend the electronic device from a desired object; and a view angle adjuster having a base removably attached to a lower portion of the back housing of the electronic device, the view angle adjuster having a tilt arm pivotably attached to the base to set an angle of the electronic device relative to the desired object, the tilt arm moving between about zero degrees, relative to the base, to about 90 degrees, relative to the base.

These and other features, aspects and advantages of the present invention will become better understood with reference to the following drawings, description and claims.

### BRIEF DESCRIPTION OF THE DRAWINGS

FIG. 1 is a perspective view of an electronic device hanging from a hook member on a seat back according to an exemplary embodiment of the present invention;

FIG. 2 is a perspective view of an electronic device hanging from a clip member on a seat back according to an exemplary embodiment of the present invention;

FIG. 3 is an exploded perspective backside view of the electronic device of FIG. 1, illustrating the hook member and an angle base;

FIG. 4 is a perspective backside view of the electronic device of FIG. 2, illustrating the clip member and an angle base;

FIG. 5 is a perspective view of the hook member of FIG. 1, illustrating a magnetic attachment member;

FIG. 6 is a perspective view of the hook member of FIG. 1, illustrating a hook and loop attachment member;

FIG. 7 is a perspective view of the hook member of FIG. 1, illustrating a suction cup attachment member;

FIG. 8 is a perspective view of the clip member of FIG. 2, illustrating a magnetic attachment member;

FIG. 9 is a perspective view of the clip member of FIG. 2, illustrating a hook and loop attachment member;

FIG. 10 is a perspective view of the clip member of FIG. 2, illustrating a suction cup attachment member;

FIG. 11 is a perspective view of the angle base member of FIGS. 3 and 4, illustrating a magnetic attachment member;

FIG. 12 is a perspective view of the angle base member of FIGS. 3 and 4, illustrating a hook and loop attachment member; and

FIG. 13 is a perspective view of the angle base member of FIGS. 3 and 4, illustrating a suction cup attachment member.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a detachable hook or clip with view angle adjuster for hanging an electronic device in various settings. The device of the present invention includes a flexible hook or clip and a view angle adjuster that may be made of, for example, plastic or metal. The flexible hook or clip may be attached to the back of an electronic device using, for example, a magnetic bar, hook and loop fasteners, suction cup or the like. The hook or clip may be used to suspend the electronic device from any appropriate fixture, such as a seat back in an automobile, train, aircraft, or the like. The view angle adjuster may be attached to the lower portion of the electronic device and may be used to tilt the viewing angle of the hanging electronic device. The device of the present invention may be stowed when not in use.

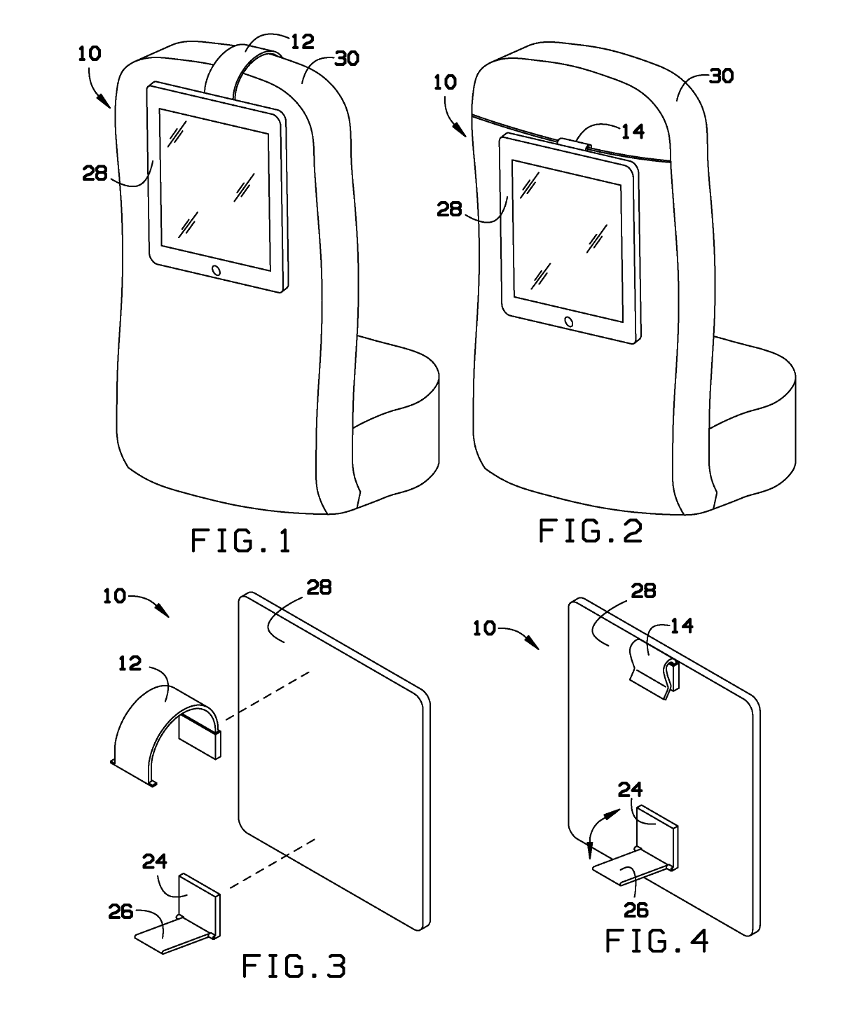

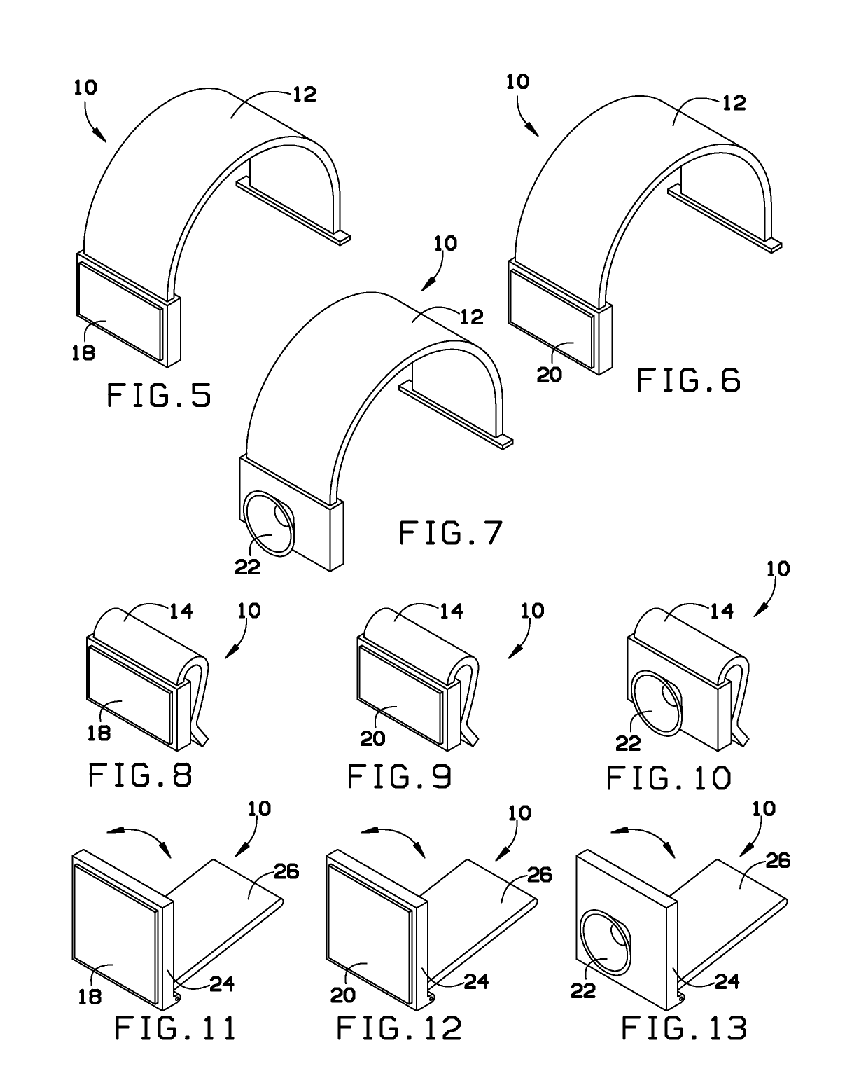

Referring now to FIGS. 1 through 13, a device 10 may include a hook 12 or a clip 14. The hook 12 may be a flexible hook made of, for example, plastic, metal, composite, or the like, that may flex over, for example, a seat back 30. The hook 12 may include a flexible, resilient hook for applying the hook to various items, such as a seat back pocket, for example. The hook 12 can be shaped generally in a U-shape, where the length of one of the sides of the U-shape may be the same or different from the length of the other side of the U-shape.

Both the hook 12 and the clip 14 may have an attachment area for attaching the hook 12 or the clip 14 to a back side of an electronic device 28 (or to a case or housing for the electronic device 28). The attachment area may be a generally flat area and may include any number of attachment mechanisms. For example, the attachment area of the hook 12 and the clip 14 may include a magnet 18, hook and loop fastener 20, such as Velcro®, or a suction cup 22. These mechanisms, as well as others known in the art, may be used to removably attach the hook 12 or the clip 14 to the electronic device 28.

A view angle adjuster 16 may be applied to a lower portion of the back side of the electronic device 28. The view angle adjuster 16 may attach in the same or in a different way from the hook 12 or the clip 14. For example, the view angle adjuster 16 may include a base 24 having a magnet 18, hook and loop fastener 20, such as Velcro®, or a suction cup 22.

The view angle adjuster 16 may include a tilt arm 26 that may pivot on the base 24. The tilt arm 26 may retain its position when set at a given angle relative to the base 24. The tilt arm 26 can pivot from the base 24 between an angle of zero degrees (minimum tilt relative to the seat back 30) to about 90 degrees (maximum tilt relative to the seat back 30). The tilt arm 26 may support the electronic device 28 at a particular angle when the electronic device 28 is hung by the hook 12 or the clip 14. The length of the tilt arm 26 may be fixed or may be adjustable. The overall length of the tilt arm 26 may be between about 1 inch and about 6 inches, typically between 1 inch and about 3 inches.

The device 10 of the present invention can be used in various environments, such as vehicles, aircraft, trains and the like. While the Figures show the electronic device 28 disposed in a portrait position, the removably attachable clip 14 or hook 12 can be positioned to retain the electronic device 28 in a landscape position, where the view angle adjuster 16 can be positioned opposite the clip 14 or hook 12.

It should be understood, of course, that the foregoing relates to exemplary embodiments of the invention and that modifications may be made without departing from the spirit and scope of the invention as set forth in the following claims.

What is claimed is:

1. A device for supporting an electronic device comprising:
at least one of a hook or a clip removably attached to an upper portion of a back housing of the electronic device, the hook and clip adapted to suspend the electronic device from a desired object; and
a view angle adjuster having a base removably attached to a lower portion of the back housing of the electronic device, the view angle adjuster having a tilt arm adapted to set an angle of the electronic device relative to the desired object.

2. The device of claim 1, wherein the hook has a U-shape operable to resiliently fit over a seat back.

3. The device of claim 1, wherein the hook or clip is removably attached to the electronic device by one of a magnet, a hook and loop fastener, and a suction cup.

4. The device of claim 1, wherein the view angle adjuster is removably attached to the electronic device by one of a magnet, a hook and loop fastener, and a suction cup.

5. The device of claim 1, wherein the tilt arm adjustably pivots from the base of the view angle adjuster between zero degrees to about 90 degrees.

6. A device for supporting an electronic device comprising:
at least one of a U-shaped hook or a clip removably attached to an upper portion of a back housing of the electronic device, the hook and clip adapted to suspend the electronic device from a desired object; and
a view angle adjuster having a base removably attached to a lower portion of the back housing of the electronic device, the view angle adjuster having a tilt arm pivotably attached to the base to set an angle of the electronic device relative to the desired object, the tilt arm moving between about zero degrees, relative to the base, to about 90 degrees, relative to the base.

7. The device of claim 1, wherein the hook or clip and the view angle adjuster is removably attached to the electronic device by one of a magnet, a hook and loop fastener, and a suction cup.
